(19) United States
(12) Patent Application Publication
(10) Pub. No.: US 2007/0290001 A1
(43) Pub. Date: Dec. 20, 2007

(54) Portable beverage dispensing apparatus

(76) Inventor: James Daniel Bachrach, Lawrenceville, GA (US)

Correspondence Address: EDWIN TARVER, 16830 Ventura Blvd., SUITE 360, Encino, CA, 91436, US

(21) Appl. No.: 11/455,878

(22) Filed: Jun. 17, 2006

(51) Int. Cl. B67D 5/06

(52) U.S. Cl. 222/183

(57) ABSTRACT

An apparatus for storing and dispensing multiple beverages. The apparatus comprises a housing, a handle on the housing and a plurality of beverage canisters. The housing defined by a base, top, front, back and pair of side surfaces includes a plurality of compartments for receiving the beverage canisters. The front surface of the housing is attached to the housing using hinges and can be opened or closed to cover or uncover the compartments. Each canister includes an opening on its top surface, a spout at the bottom of its front surface and a handle on its front surface. The opening is hermetically sealed using a cap. The front surface of the housing includes a rotational numbered dial system and a beverage level indicating means corresponding to each compartment, and grooves of suitable sizes to accommodate the spouts of the canisters.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to beverage dispensing apparatuses in general, and more particularly to a portable beverage dispensing apparatus for storing and dispensing multiple beverages.

A variety of storage means are used to store cold and hot beverages. Currently, these storage means, such as containers, differ in size and shape. Therefore, carrying and handling multiple beverage containers frequently becomes awkward and difficult. An apparatus comprising a plurality of identical containers for storing and dispensing beverages is needed to provide a convenient means to handle multiple beverages.

Several beverage dispensing apparatuses have been developed in the art. For example, U.S. Pat. No. 4,143,795 to Casebier discloses a refrigerator beverage dispenser comprising multiple containers fitted in a rack that can rest on the shelf of a refrigerator. The rack consists of a rectangular housing made up of longitudinal and transverse ribs. The front of each container is concave to accommodate a cup or similar receptacle for filling from a dispenser spout that extends forward from the bottom front of the container. The container can be removed from the rack by sliding it forward when a hinged retaining gate is lowered. However, this device lacks any features that confer portability for outdoor use. Moreover, this beverage dispenser lacks any beverage level indicating means.

U.S. Pat. No. 5,335,829 to Sovann discloses a portable knockdown dispenser kit to be used in conjunction with two-liter beverage bottles. The dispenser supports the bottles in an inverted position and is placed on a horizontal surface for outdoor use. A support cabinet is provided for housing the bottle during use. This dispenser uses conventional two-liter bottles, rather than specially designed containers disposed in a conveniently portable housing for storing and dispensing beverages.

U.S. Pat. No. 6,269,980 to Randall discloses a beverage dispenser having an upper housing and a lower base with a sealing gasket for attaching the housing to the base. Both the housing and the base are filled with a foam core having multiple cavities for receiving multiple dispensing bottles. Bottles are connected by sockets to a liquid reservoir having an air vent and a spigot. This dispenser can be used for only one beverage at a time, as it employs a single liquid reservoir as opposed to the present invention.

Due to the limitations of beverage dispensers known in the art, there is a need for an improved beverage dispenser. It is therefore an object of the present invention to provide an improved beverage dispensing apparatus that is portable and convenient to handle.

A further object is to provide a portable beverage dispensing apparatus that includes an insulated housing and a plurality of containers disposed in housing.

A further object is to provide a portable beverage dispensing apparatus that can be used to carry multiple beverages.

A further object is to provide a portable beverage dispensing apparatus that includes a beverage level indicator.

A further object is to provide a portable beverage dispensing apparatus that includes a beverage expiration date indicator, which can be adjusted by a user.

Finally, it is an object of the present invention to provide a portable beverage dispensing apparatus that includes a labeling means to identify a beverage within each container. These and other objects of the present invention will become better understood with reference to the appended Summary, Description, and Claims.

### SUMMARY

The present invention is a portable beverage dispensing apparatus comprising a plurality of beverage canisters and a housing. The housing, defined by base, top, front, back, and pair of side surfaces, includes a plurality of compartments for receiving the beverage canisters. The front surface of the housing comprises a separate piece secured to the top front edge of the housing using a hinge. The front surface includes a plurality of vertical transparent sections, each corresponding to one of the compartments. A rotational numbered dial is also included on the front surface corresponding to each compartment.

Each canister includes a spout at the bottom of its front surface and an opening on its top surface. A cap is used to hermetically seal each opening. Each canister is filled with a beverage and inserted into one of the compartments. The front surface of the housing is designed to accommodate the spout after the canisters are inserted in their respective compartments. Once all the canisters are inserted, the front surface is closed to seal the housing and the spouts project out from the housing. The canisters are transparent, and therefore the beverage level can be viewed through the transparent sections on the front surface of the housing.

### BRIEF DESCRIPTION OF THE FIGURES

FIG. 1 is a perspective view of the housing of the beverage dispensing apparatus with the front panel closed in accordance with the present invention.

FIG. 2 is a perspective view of the housing of the beverage dispensing apparatus with the front panel opened in accordance with the present invention.

FIG. 3 is a perspective view of the canister of the beverage dispensing apparatus in accordance with the present invention.

FIG. 4 is a perspective view of the beverage dispensing apparatus with the front panel opened and the canisters inserted in the housing in accordance with the present invention.

FIG. 5 is a perspective view of the beverage dispensing apparatus with the canisters inserted in the housing and the front panel closed in accordance with the present invention.

### FIGURES—REFERENCE NUMERALS

10 . . . Beverage Dispensing Apparatus
12 . . . Housing
14 . . . Beverage Canister
16 . . . Base of the Housing
18 . . . Top Surface of the Housing
20 . . . Handle of the Housing
22 . . . Canister Compartment
24 . . . Face Panel
26 . . . Lip Member
28 . . . Hinge
30 . . . Indentation
32 . . . Labeling Means
34 . . . Transparent Section
36 . . . Rotational Numbered Dial
38 . . . Spout Lip
40 . . . Top Surface of the Canister
42 . . . Front Surface of the Canister
44 . . . Cap
46 . . . Handle of the Canister
48 . . . Spout
50 . . . Push Button
52 . . . Magnet
54 . . . Plate

### DETAILED DESCRIPTION

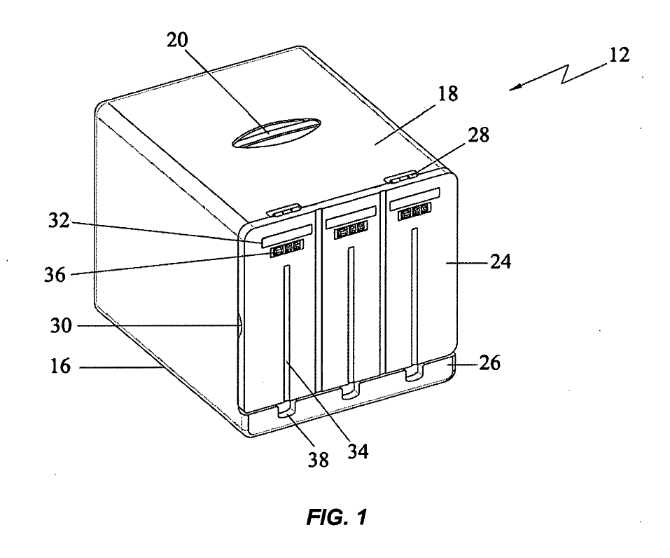

Referring to the drawings, the preferred embodiment of a beverage dispensing apparatus 10 is illustrated in FIGS. 1 through 5. The beverage dispensing apparatus 10 comprises of a housing 12 and a plurality of transparent beverage canisters 14 received within the housing 12.

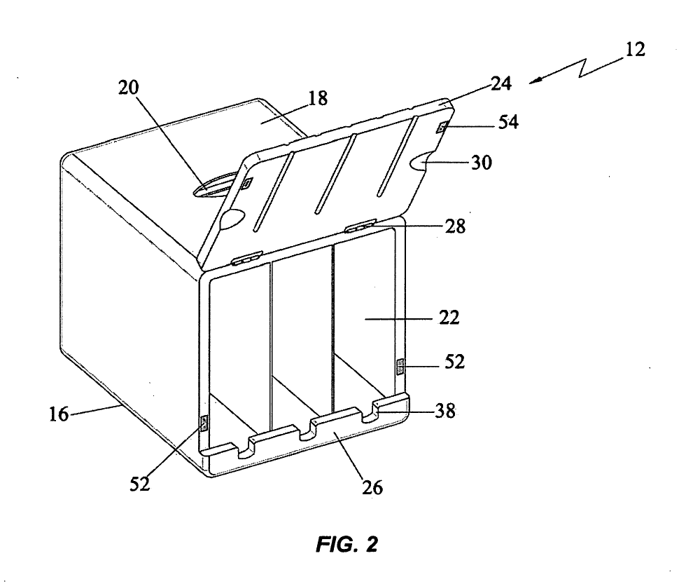

Referring to FIGS. 1 and 2, the housing 12 is defined by base 16, top 18, front, back and pair of side surfaces. The housing 12 includes a retractable handle 20 on its top surface 18 and a plurality of compartments 22. The housing, including three compartments, is illustrated by the figures. The handle 20 becomes flush with the top surface 18, when depressed. Each compartment is adapted to receive a beverage canister. The interior of the base 16 is tapered downward toward the front of the housing 12 to enable beverages to flow toward the spout after the canisters 14 are inserted in the compartments 22.

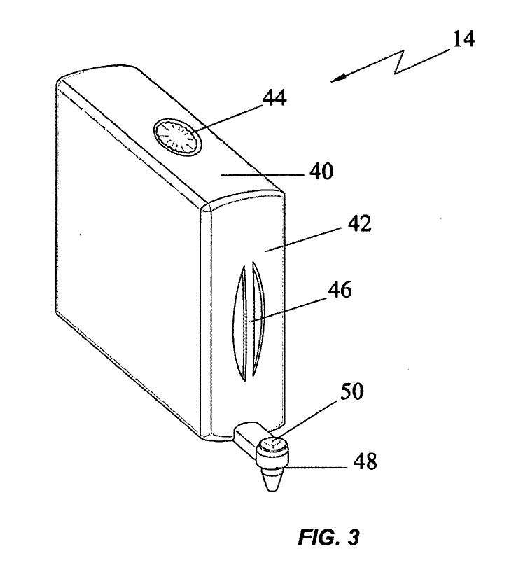

Referring to FIG.3, each canister 14 is defined by base, top 40, front 42, back, and pair of side surfaces. The canister includes an opening on its top surface 40, a handle 46 on its front surface and a spout 48 at the bottom of the front surface. The opening serves as an inlet for filling beverages. A cap 44 along with a rubber seal or gasket is used to hermetically seal the opening, by means of threading (not shown) disposed on both the cap and the opening. The cap 44 becomes flush with the top surface 40 of the canister 14 after it completely seals the opening. The spout 48 is removable and includes a push button 50 for discharging the beverage in the canister. The base of the canister 14 is slightly curved for enabling the beverages to flow towards the spout 50.

The front surface of the housing 12 is comprised of a face panel 24 and a bottom lip member 26, as seen in FIGS. 1 and 2. The face panel 24 is secured to the top edge of the housing using hinges. The plurality of compartments 22 can be accessed by moving the face panel 24 about the hinges 28. The face panel 24 includes indentations 30 on its side surfaces, which facilitate hand placement while opening it. The face panel 24 includes metal plates 54, which abut magnets 52 on the housing after the face panel covers the compartments. The magnetic attraction between the metal plates and magnets hold the face panel 24 in place. The lip member 26 includes a plurality of spout lips 38, each corresponding to one of the compartments. The spout lips are adapted to receive a portion of the spouts of the canisters.

The face panel 24 further includes a plurality of labeling means 32, rotational numbered dial systems and vertical transparent sections 34 corresponding to each compartment. The labeling means may comprise name plaques with interchangeable tiles and a plurality of self-adhesive labels. The labels can be imprinted with the name of a beverage and adhered to the tiles for identifying the beverages in each compartment. The numbered dial system includes three individual rotational numbered dials 36, namely, a first dial numbered 1 to 12 for displaying a month, and second and third dials numbered from 0 to 9 for displaying a day.

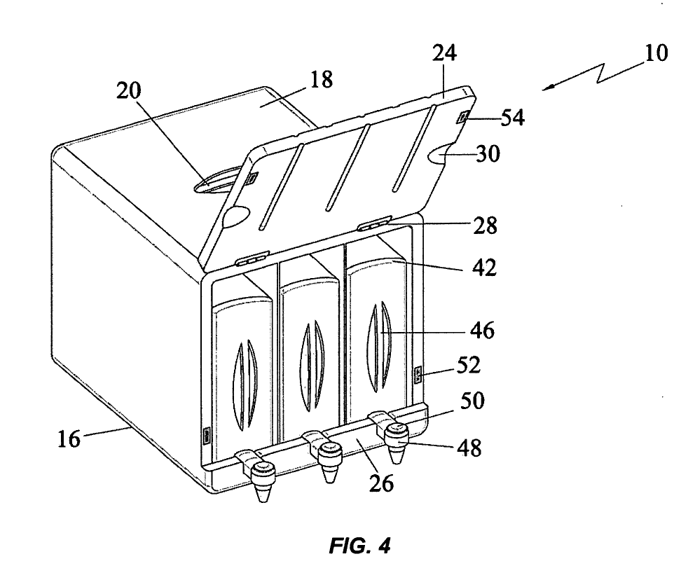

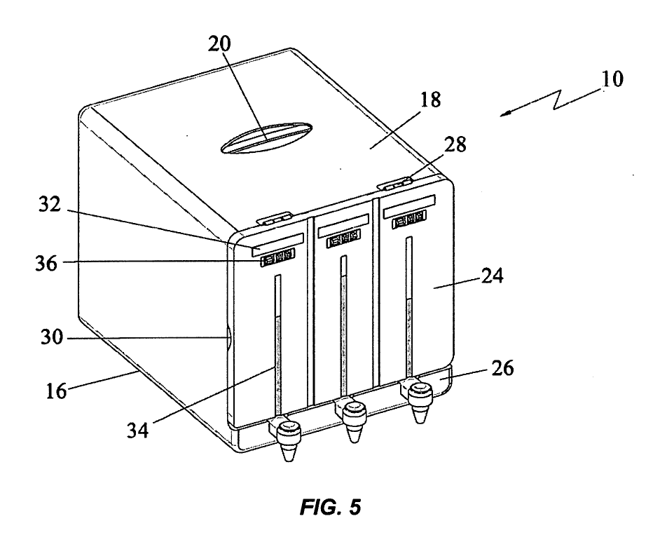

Referring to FIGS. 4 and 5, the transparent canisters 14 are held with the handle 46 and inserted into their respective compartments. A portion of the spout 48 is received in the spout lip 38 of the lip member 26 before the face panel 24 is closed. The spouts 48 project outwardly from the housing and are held between the spout lips 38 of the face panel 24 and the lip member 26. The handles 46 of the beverage canisters are disposed directly in front of the transparent sections 34. The beverage levels in the transparent canisters can therefore be viewed through the transparent sections 34 on the face panel 24 of the housing. The handles 46 are hollow and allow beverages to pass through, without obstructing the view of the beverage level. In order to remove a canister 14 from its respective compartment 22, the face panel 24 is opened and the canister 14 is lifted up and pulled outwards using the handle 48.

A variety of materials can be used to comprise the canisters and housing. The beverage canisters can be made of hard plastic or other durable materials that are suitable for holding either cold or hot beverages. For example, the canisters can be made of stainless steel for storing hot beverages. The housing can be made of insulated plastic or another suitable material, including a material with an insulated lining on its interior surface. The materials used for the housing may be adapted for either cold or hot beverages.

Several alternate embodiments are possible for the beverage dispensing apparatus 10 of the present invention. For example, two, three, or another number of canisters can be designed into the apparatus. The apparatus 10 can also be used for cooling warm beverages in the beverage canisters by inserting cold packs in the housing.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A portable beverage dispensing apparatus, comprising:
(a) a plurality of transparent beverage canisters, each defined by a front, back, top, base, and pair of side surfaces, each canister including an opening on its top surface, a spout at the bottom of its front surface, and a handle on its front surface, the opening being hermetically sealed using a cap; and
(b) a housing defined by a front, back, top, base, and pair of side surfaces, the housing including a plurality of compartments, each being adapted to receive one of the beverage canisters, a retractable handle, a rotational numbered dial system corresponding to each compartment, and a beverage level indicating means corresponding to each compartment, the front surface comprising a separate piece attached to the housing using a hinge and includes grooves to accommodate the spouts, such that the spouts project outwardly from the housing when the canisters are received within their respective compartments and the front surface is moved down to cover the compartments.

2. The beverage dispensing apparatus of claim 1, wherein the front surface of the housing is divided into a face panel attached to the housing using a hinge and a bottom lip member including the grooves corresponding to each compartment for accommodating the spouts.

3. The beverage dispensing apparatus of claim 2, wherein the face panel is moved down to cover the compartments after the canisters are received in their respective compartments, whereby the spouts are held between the grooves and the face panel, securing the beverage canisters in the housing.

4. The beverage dispensing apparatus of claim 3, wherein the face panel includes a plurality of metal plates that abut a plurality of magnets on the housing when the face panel covers the compartments, thereby securing the face panel.

5. The beverage dispensing apparatus of claim 2, wherein the face panel is attached to the front top edge of the housing.

6. The beverage dispensing apparatus of claim 2, wherein the face panel comprises a vertical transparent section corresponding to each compartment for viewing the beverage level in the transparent beverage canisters.

7. The beverage dispensing apparatus of claim 1, wherein the housing further includes a plurality of labeling means corresponding to each compartment, wherein the labeling means are used to identify the beverages in the beverage canisters after they are received in their respective compartment.

8. The beverage dispensing apparatus of claim 7, wherein the labeling means comprise name plaques with interchangeable tiles and adhesive labels with imprinted beverage titles for attachment to the tiles.

9. The beverage dispensing apparatus of claim 1, wherein the rotational numbered dial system comprises a plurality of individual numbered dials, which are adjusted to set an expiry date for the beverages in the beverage canisters.

10. The beverage dispensing apparatus of claim 9, wherein the rotational numbered dial comprises three individual numbered dials, a first dial numbered 1 through 12 for displaying a month, a second and third dials numbered 0 through 9 for displaying a day.

11. The beverage dispensing apparatus of claim 1, wherein the front surface comprises a vertical transparent section corresponding to each compartment for viewing the beverage level in the transparent beverage canisters, the handles of the beverage canisters being hollow to allow the beverages to pass through without obstructing the view of the beverage level.

12. The beverage dispensing apparatus of claim 1, wherein the spouts are removable.

13. The beverage dispensing apparatus of claim 1, wherein the interior of the base of the housing tapers downwardly towards the front surface of the housing to allow the beverages in the canisters to flow towards the spouts.

14. The beverage dispensing apparatus of claim 1, wherein the caps are flush with the top surfaces of the beverage canisters and a rubber seal or gasket is used to achieve a hermetic seal.

15. The beverage dispensing apparatus of claim 1, wherein the beverage canisters are made of hard plastic or other durable materials that are suitable for containing either cold or hot beverages.

16. The beverage dispensing apparatus of claim 1, wherein the housing is made of insulated plastic or another material with an insulated lining on its interior surfaces.

17. The beverage dispensing apparatus of claim 1, wherein the housing is made of suitable materials with insulating properties, making it adaptable for either cold or hot beverages.

18. The beverage dispensing apparatus of claim 17, wherein the beverage canisters are made of stainless steel for storing hot beverages.

19. The beverage dispensing apparatus of claim 1, wherein the apparatus comprises two or three beverage canister versions.
